(19) United States
(12) Patent Application Publication
(10) Pub. No.: US 2012/0005713 A1
(43) Pub. Date: Jan. 5, 2012

(54) METHODS, SYSTEMS, AND COMPUTER PROGRAM PRODUCTS FOR CONFIGURING ACCESS TO A DATA SOURCE BASED ON A CHANNEL IDENTIFIER

(76) Inventor: Robert Paul Morris, Raleigh, NC (US)

(21) Appl. No.: 12/830,385

(22) Filed: Jul. 5, 2010

(51) Int. Cl. H04N 7/173

(52) U.S. Cl. 725/118

(57) ABSTRACT

Methods and systems are described for configuring access to a data source based on a channel identifier. First channel information identifying a first channel is received. The first channel identifier is bound to a frequency channel accessible via a tuner. First access information is received for accessing a first data source not accessible via the tuner. A binding between the first channel identifier and the first channel access information is created. The binding is stored in a data store to locate the access information based on a selection of the channel identifier; so that data from the first data source is accessed from the first data source rather than accessing data received in the first frequency channel.

### RELATED APPLICATIONS

This application is related to the following commonly owned U.S. Patent Applications, the entire disclosure of each being incorporated by reference herein: Application No. ______, (Docket No 0160) filed on Jul. 5, 2010, entitled “Methods, Systems, and Program Products for Processing Contextual Channel Identifiers”;

Application No. ______, (Docket No 0161) filed on Jul. 5, 2010, entitled “Methods, Systems, and Program Products for Selecting a Data Source Based on a Channel Identifier”; and

Application No. ______, (Docket No 0165) filed on Jul. 5, 2010, entitled “Methods, Systems, and Program Products for Configuring a Contextual Channel Identifier”.

### BACKGROUND

Current television sets and media centers allow users to access data from sources other those received via television signals. To view a frequency channel received by a television tuner, a user provides a channel identifier via numeric keypad and/or directional navigation key(s). Accessing data sources other than via a television tuner is more complicated. For example, accessing data from a DVD in a DVD player currently requires users to press various menu and navigation buttons to select a communications port such as a high-definition multimedia interface (HDMI) communications port connecting the DVD player and the television device. Alternatively or additionally a user may enter, typically via keyboard or menu, information for locating and/or otherwise accessing a data source via a data provider other than the television tuner. For example, a user may type in a universal resource locator (URL) to access a network-based data source via a network interface component, such as an Ethernet adapter. While current user interfaces are powerful, current interfaces are relatively complex.

Accordingly, there exists a need for methods, systems, and computer program products for configuring access to a data source based on a channel identifier.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for configuring access to a data source based on a channel identifier. In one aspect, the method includes receiving first channel information identifying a first channel identifier bound to a first frequency channel accessible via a tuner. The method further includes receiving first access information for accessing a first data source not accessible via the tuner. The method still further includes creating a binding between the first channel identifier and the first access information. The method additionally includes storing the binding in a data store to locate, based on a selection of the channel identifier, the access information for accessing data from the first data source rather than accessing data received in the first frequency channel.

Further, a system for configuring access to a data source based on a channel identifier is described. The system includes an execution environment including an instruction processing unit configured to process an instruction included in at least one of a channel association component, an access configuration component, an access binder component, and an access manager component. The system includes the channel association component configured for receiving first channel information identifying a first channel identifier bound to a first frequency channel accessible via a tuner. The system further includes the access configuration component configured for receiving first access information for accessing a first data source not accessible via the tuner. The system still further includes the access binder component configured for creating a binding between the first channel identifier and the first access information. The system still further includes the access manager component configured for storing the binding in a data store to locate, based on a selection of the channel identifier, the access information for accessing data from the first data source rather than accessing data received in the first frequency channel.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for configuring access to a data source based on a channel identifier according to an aspect of the subject matter described herein;

FIG. 3 is a flow diagram illustrating a method for selecting a data source based on a channel identifier according to another aspect of the subject matter described herein;

FIG. 4a is a block diagram illustrating an arrangement of components for configuring access to a data source based on a channel identifier according to another aspect of the subject matter described herein;

FIG. 4b is a block diagram illustrating an arrangement of components for selecting a data source based on a channel identifier according to another aspect of the subject matter described herein;

FIG. 5 is a block diagram illustrating an arrangement of components for configuring access to a data source based on a channel identifier according to another aspect of the subject matter described herein;

FIG. 6 is a network diagram illustrating an exemplary system for configuring access to a data source based on a channel identifier according to another aspect of the subject matter described herein;

FIG. 7a is a diagram illustrating a user interface presented via a display according to another aspect of the subject matter described herein; and

FIG. 7b is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

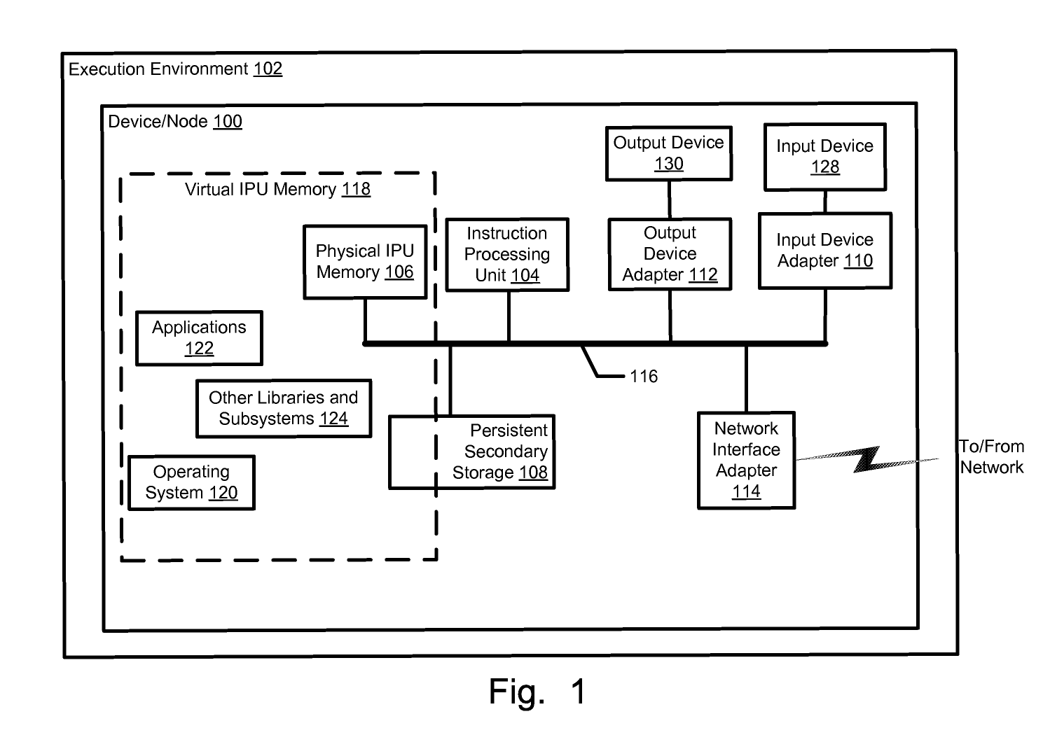

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include televisions, audio receivers, media servers, personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and/or other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “device” and “node” as used herein refer to one or more devices and nodes, respectively, providing and/or otherwise included in an execution environment unless clearly indicated otherwise.

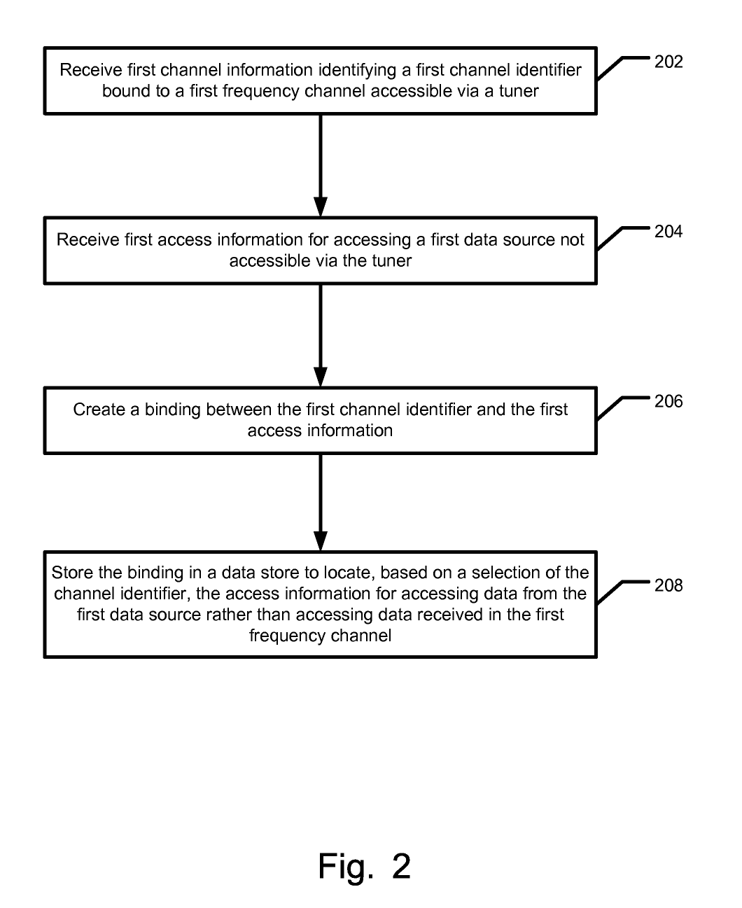

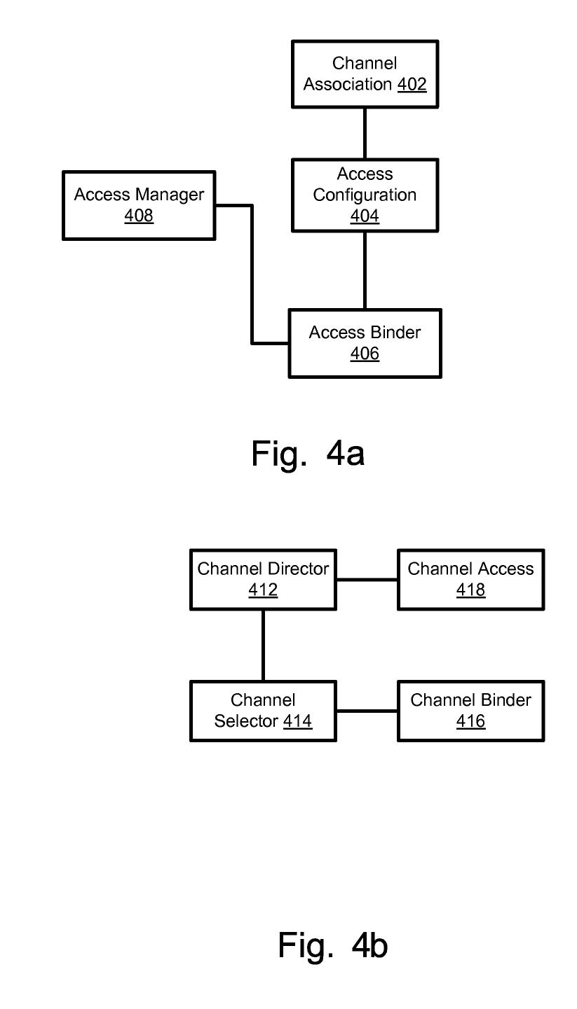

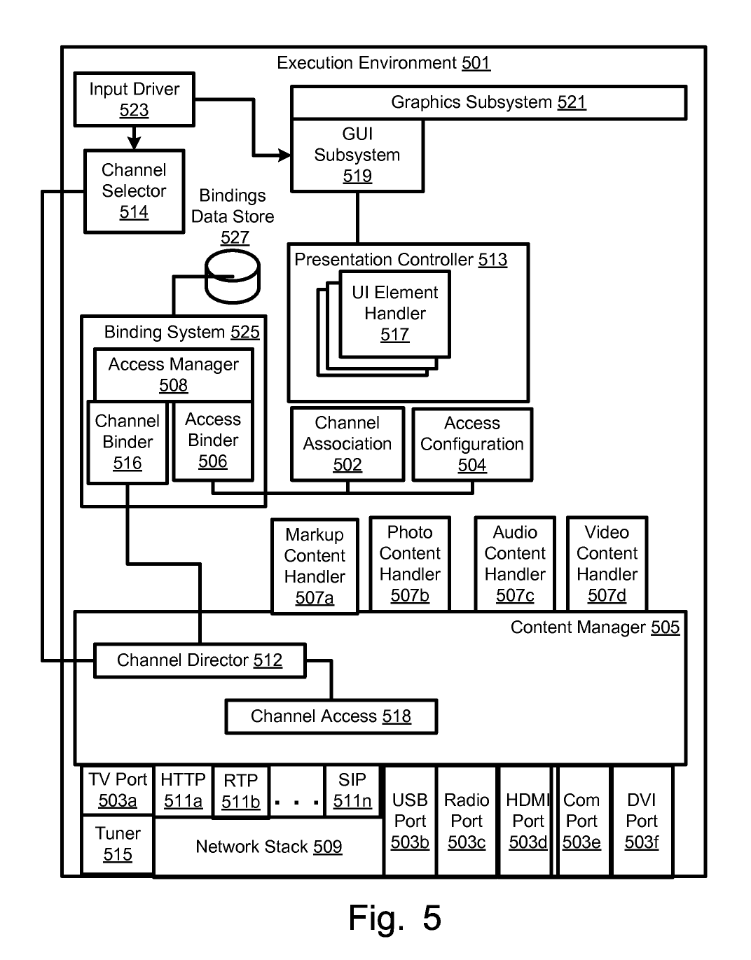

The block diagram in FIG. 4a illustrates an exemplary system for configuring access to a data source based on a channel identifier according to the method illustrated in FIG. 2. A system for performing the method illustrated in FIG. 2 includes an execution environment, including an instruction-processing unit, configured to process an instruction included in at least one of a channel association component 402, an access configuration component 404, an access binder component 406, and an access manager component 408 illustrated in FIG. 4a. Some or all of the exemplary components illustrated in FIG. 4a may be adapted for performing the method illustrated in FIG. 2 in a number of execution environments. FIG. 5 is a block diagram illustrating the components of FIG. 4a and/or analogs of the components of FIG. 4a adapted for operation in execution environment 501 including or otherwise provided by one or more nodes.

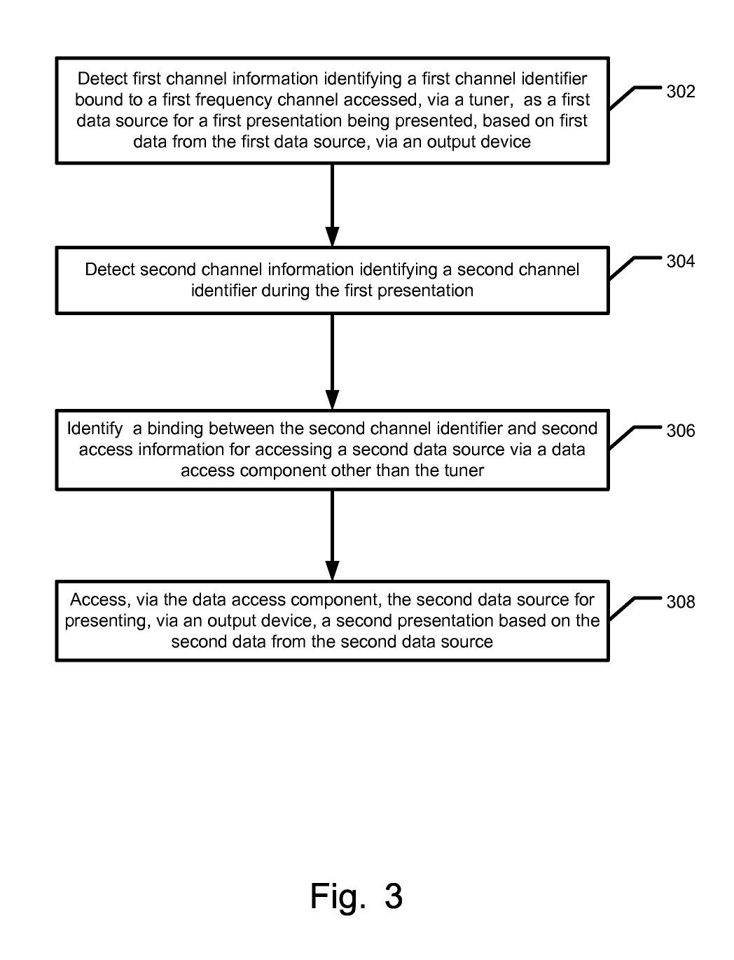

The block diagram in FIG. 4b illustrates an exemplary system for selecting a data source based on a channel identifier according to the method illustrated in FIG. 3. A system for performing the method illustrated in FIG. 3 includes an execution environment, including an instruction-processing unit, configured to process an instruction in at least one of a channel director component 412, a channel selector component 414, a channel binder component 416, and a channel access component 418 illustrated in FIG. 4b. Some or all of the exemplary components illustrated in FIG. 4b may be adapted for performing the method illustrated in FIG. 3 in a number of execution environments. FIG. 5 is a block diagram illustrating the components of FIG. 4b and/or analogs of the components of FIG. 4b adapted for operation in execution environment 501 including or otherwise provided by one or more nodes.

FIG. 1 illustrates components of an exemplary device that may at least partially provide and/or otherwise be included in an execution environment. The components illustrated in FIG. 4 and FIG. 5 may be included in or otherwise combined with the components of FIG. 1 to create a variety of arrangements of components according to the subject matter described herein.

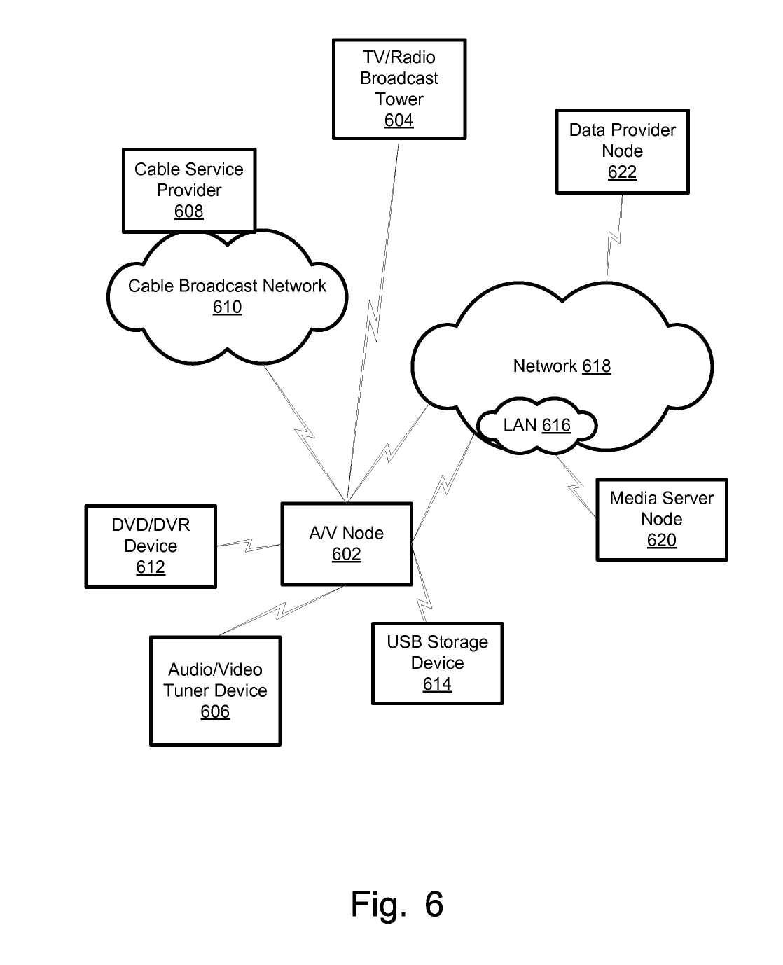

FIG. 6 illustrates audio/video (A/V) node 602 as an exemplary device or node including and/or otherwise operatively coupled to a tuner for receiving data from a frequency channel for presenting via an output device. A/V node 602 may include a television and/or a radio. A/V node 602 may be communicatively coupled to a variety of data providers. FIG. 6 illustrates that A/V node 602 may be communicatively coupled to one or more over-the-air broadcast television and/or radio stations represented by TV/radio broadcast tower 604. The television (TV) and/or radio data provider(s) may be accessed via a tuner for receiving over-the-air broadcast signals via an antenna. The tuner may be included in A/V node 602 and/or may be external to and operatively coupled to A/V node 602 as illustrated by audio/video tuner device 606. A/V node 602 may receive television and/or radio broadcast data from a cable service provider 608 via a physical coupling to cable service provider's 608 cable broadcast network 610. A/V node 602 may include a cable tuner and/or may be operatively coupled to an external cable tuner, for example, in a set-top box. A/V node 602 may include one or more communications ports for directly connecting to a data provider. Exemplary service ports include a high-definition multimedia interface (HDMI), a digital video interface (DVI), a composite interface, and a universal serial bus (USB) port. Exemplary data providers that may be coupled to and/or included in A/V node 602 via a communications port include a digital video disc (DVD) device and/or digital video recording (DVR) device 612, a video cassette recording (VCR) device (not shown), a compact disc (CD) player (not shown), and/or a universal serial bus (USB) mass storage device 614. In another aspect, A/V node 602 may be operatively coupled to one or more data sources via one or more networks, such as LAN 616, in a home or business. LAN 616 may be included in a network, such as network 618 that may include the Internet. A/V node 602 may be communicatively coupled to various data providers in the home or business, such as a media server node 620, a desktop PC, a laptop, a netbook, a smart phone, and/or a tablet computing device. A/V node 602 may be communicatively coupled to one or more Internet data providers including media content providers and document providers. Data provider node 622 illustrates an Internet data provider. A communicative coupling may be persistent, remaining even while content via the coupling is not being presented by A/V node 602 via an output device. A communicative coupling may be temporary, becoming active and remaining active while content via the coupling is being presented by A/V node 602 and/or otherwise actively processed. For example content not being presented may be stored in a data storage media component or device such as DVD/DVR device 612 and/or USB storage device 614 for later access.

FIG. 5 illustrates exemplary execution environment 501 including and/or provided by A/V node 602. Execution environment 501 of A/V node 602 may include an arrangement of components for receiving analog signals and/or digitally modulated information transmitted over the air (wirelessly) and/or via a broadcast data network such as provided by cable television service provider 608. Digitally modulated information is transmitted according to a specified format. For example, high-definition television (HDTV) format differs from standard-definition, and digital formats differ from analog. A/V node 602 may be configured to receive and process television signals according to one or more broadcast formats. A/V node 602 may include one or more port components 503 illustrated in execution environment 501 in FIG. 5. Television signals transmitted by an over-the-air broadcaster via TV/radio broadcast tower 604 may be received via an antenna coupled to A/V node 602 via tuner component 515 and TV port 503a. TV port component 503a may alternatively or additionally receive, via broadcast network 610, signals of cable service provider 608. A/V node 602 may include one or more TV port components 503a.

A/V node 602 includes content manager component 505 in FIG. 5. Content manager component 505 may perform some preprocessing of data from one or more port components 503. For example, content manager component 505 may decompress and/or amplify digital television data received via TV port component 503a. Alternatively or additionally, for data received from at least some port components 503, content manager component 505 may provide the data to one or more content handler components 507 based on the port(s) providing the data and/or the format(s) or content type of the data received. Content manager component 505 may include hardware and/or software. For example, content manager component 505 may include a system on chip (SOC). Content manager component 505 may process all incoming video and audio received via one or more of TV port component 503a, USB port component 503b, radio port component 503c, HDMI port component 503d, composite input port component (com port) 503e, and DVI port component 503f, to name a few examples.

Content manager component 505 may also process data received via network 618 via a network interface component illustrated in FIG. 1, such as an Ethernet adapter. Data received via a network interface component may be processed via one or more layers of network stack 509 such as a TCP/IP stack and optionally processed by one or more protocol components 511 configured to process received data according to a session, presentation, and/or application layer protocol. FIG. 5 illustrates that execution environment 501 of A/V node 602 includes HTTP component 511a for processing data according to hypertext transfer protocol (HTTP), real-time transport protocol (RTP) component 511b for various forms of streamed data, session initiation protocol (SIP) component 511n for processing data according to a session initiation protocol (SIP), and/or other protocol components (not shown).

A Content handler component 507 may process data according to the data's content type to produce presentation information to send to an output device, such as a display and/or a speaker, to present to a user. For example, data from TV port 503a may be decompressed by content manager 505 in order to provide an audio portion of the data to a suitable audio content handler 507c and a video portion of the data to a video content handler 507d.

Output generated by audio content handler 507c may be routed to speakers, stereo line outs, and/or headphones. Output of video content handler component 507d may be routed to a display driver for a display device, such as an LCD screen. Content handlers 507 may include and/or retrieve decoders and encoders as required based on various types of media containers and content types. For example MPEG-2 decoders and/or composite video encoders may be included and/or otherwise accessible to one or more content handlers 507.

If a TV port is configured to receive an analog signal, the signal may be converted by a first content handler to a digital signal for processing by one or more audio and video content handlers. Content handlers 507, in an aspect, may be operatively coupled in chains of content handlers 507 to process received data. The chains may be persistently configured or configured dynamically as needed by content manager component 505.

Received data may include synchronization information and/or metadata such as text for closed captioning. Metadata may be handled by a suitable content handler component 507. For example, metadata specified according to resource definition framework (RDF) may be processed by a content handler for processing extensible markup language (XML) formatted data. Presentation controller component 513 may receive synchronization information and process output of one or more content handler components 507 according to the synchronization information. Metadata for closed captioning may be provided to a content handler 507 based on the content type of the captioning data.

TV port 503a may include a television tuner component 515 and/or may be operatively coupled to a frequency tuner component, such as audio/video tuner device 606. TV port component 503a may output data at a fixed frequency and/or otherwise in a fixed format regardless of the channel received by the tuner. TV port component 503a may output a frequency channel from multiple frequency channels receivable by the tuner component 515 and/or audio/video tuner device 606. If a user selects channel identifier “2”, the picture and audio encoded in the electromagnetic waves corresponding to channel identifier “2” are detected by the tuner and encoded by the tuner and/or TV port component 503a to a standard frequency, referred to as the “intermediate frequency”, and/or other suitable encoding. The output of TV port 503a may be amplified by content manager 505, the data signal may be amplified by TV port 503a prior to providing the output to content manager component 505, and/or the data signal may be amplified by a content handler component 507.

Once the output of TV port component 503a is large enough to be processed, audio content handler component 507c may receive sound data from the amplified intermediate frequency signal to direct to an audio output subsystem (not shown) operatively coupled to speakers, headphones, and/or other audio output devices. Interoperation between audio content handler component 507c and the audio subsystem may be direct and/or may be mediated and/or otherwise directed by presentation controller 513. For a color television, video content handler component 507d may extract visual information, such as luminance and chrominance information from the amplified intermediate frequency signal. The information is transformed into presentation information for display by a display device.

For network data providers, FIG. 5 illustrates network stack 509 in execution environment 501 for sending and receiving messages over network 618 in FIG. 6 via a network interface component of A/V node 602. Network stack 509 may support a protocol suite, such as TCP/IP, or may communicate via a network gateway such as a cable modem or other protocol translation device and/or service.

Execution environment 501 may be configured to browse LAN 616 and/or network 618 and/or otherwise access data provider node 622 and/or media server node 620 via universal resource identifiers (URIs) identifying resources accessible via the nodes. A/V node 602 may retrieve and host a web application agent received in one or more messages sent from a web application operating in data provider node 620, for example. Content manager component 505 may interoperate with hypertext transfer protocol (HTTP) component 511a and/or network stack 509 to receive the message or messages including some or all of the web application agent.

The web application agent may include a web page or document and/or other presentation information for presenting content from data provider node 622. The web page may include and/or reference data represented in one or more formats including hypertext markup language (HTML) and/or other markup languages, ECMAScript or other scripting languages, byte code, image data, audio data, and/or machine code to name just a few valid data representations depending on the capabilities of a receiving A/V node 602.

One or more messages from data provider node 622 and/or media server node 620 may include content received by content manager component 505 via HTTP component 511a and network stack 509. In FIG. 5, content manager component 505 may provide the received content to one or more content handler components 507 to process according to the data type(s) in the received content. Content type may be identified by MIME-type identifiers. Exemplary content handler components 507 for Internet content include a text/html content handler component for processing HTML representations illustrated by markup content hander component 507a; one or more video content handler components 507d described above, one or more audio content handler components 507c also described above, and still image data content handler components illustrated by photo content handler component 507b for processing various still image data representations. Content handler component(s) 507 may provide their output to one or more user interface element handler components 517.

User interface element handler components 517 are illustrated in FIG. 5 in presentation controller component 513. Presentation controller component 513 may manage visual, audio, and other types of output for execution environment 501 as well as receive and route detected user and other inputs to components and extensions of A/V node 602. With respect to FIG. 5, a user interface element handler component 517 may be adapted to operate at least partially in a content handler component 507 such as a text/html content handler component and/or a script content handler component. Additionally or alternatively, a user interface element handler component in execution environment 501 may operate in an application agent received via a communication and/or network interface component. For example, an application agent may include a retrieved HTML document.

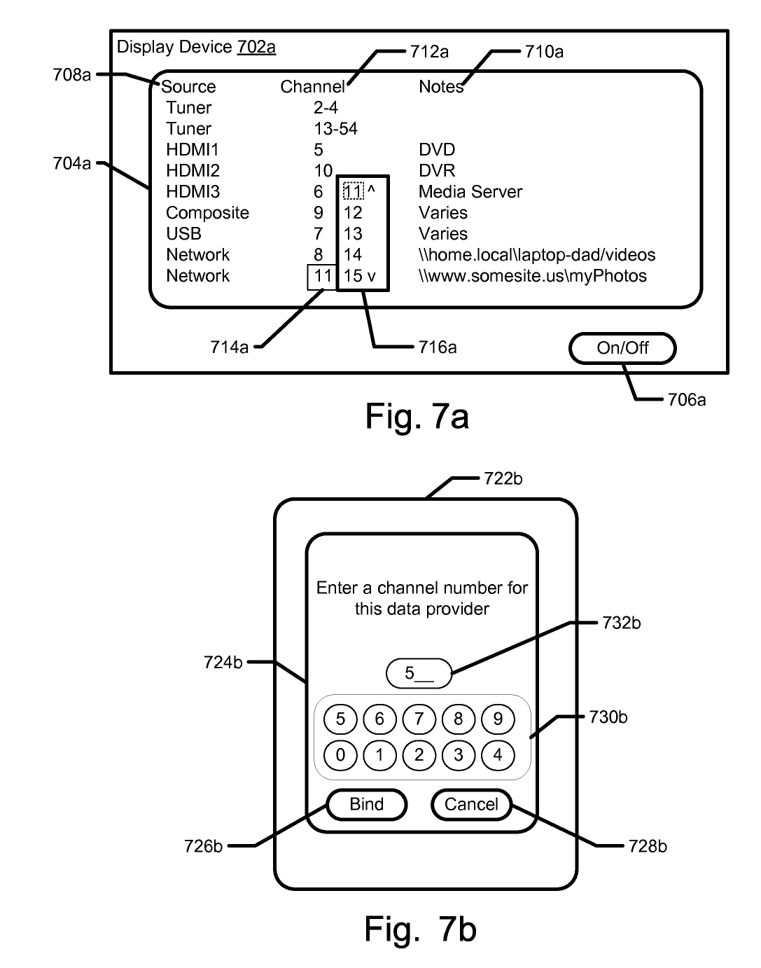

FIG. 7a illustrates a display device 702a as an exemplary output device. Display device 702a includes a presentation space 704a for presenting visual output. Display device may include one or more hardware and/or software user interface controls. On/off control 706a illustrates a hardware control for turning display device 702a on and off. A display device may be included in or may be external and operatively coupled to A/V node 602 in FIG. 6. FIG. 7b illustrates a user interface of a handheld device with user interface 722b. A/V node 602, in an adaption, may be a handheld device and execution environment 501 may include and/or otherwise be provided by a handheld device with user interface 722b. User interface 722b includes a display illustrated as presentation space 724b. Various software interface controls are illustrated including bind button 726b and cancel button 728b. Touch sensitive numeric buttons are presented in keypad user interface element 730b. One or more integers received via keypad 730b may be presented in output user interface element 732b. The user interfaces illustrated in FIG. 7a and FIG. 7b are described in more detail below.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display or a speaker. A “program entity” is an object included in and/or otherwise processed by an application or executable program component. The user detectable representation is presented based on the sent information. The sent information is referred to herein as “presentation information”. Presentation information may include data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser from a remote application provider may include HTML ECMAScript, and/or byte code for presenting one or more user interface elements included in a user interface of the remote application. Components configured to send information representing one or more program entities for presenting particular types of output by particular types of output devices include visual interface elements, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the terms “program”, “program component”, “application”, “code library”, and “executable” refer to data representations that may include and/or may be translated into a set of machine code instructions and optionally associated program data. Thus, a program or executable may include a shared library, a non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which the term “object code” is used will make clear the state of the object code when it is relevant. This definition can include machine code and virtual machine code, such as Java™ byte code.

As used herein, an “addressable entity” is a portion of a program specifiable in a source code language, which is addressable within a compatible execution environment. Examples of addressable entities include variables, constants, functions, subroutines, methods, classes, anonymous scoped instruction sets, and labeled instructions. Strictly speaking, the addressable entity contains a value or an instruction, but it is not the value or the instruction. In some places, this document will use “addressable entity” in a manner that refers to the content or value of an addressable entity. In these cases, the context will clearly indicate the intended meaning.

Addressable entities may have a number of corresponding representations. These representations include source code, object code, and any intermediate formats used by an interpreter, compiler, linker, loader, or analogous tool. Thus, terms such as “addressable source code entity” may be used in cases where the format or type of representation is relevant and may be unclear from the context.

In an aspect, various user interface elements of A/V node 602 may be presented by one or more user interface element handler components 517. User interface element handler component(s) 517 in FIG. 5 may send presentation information representing a visual interface element(s), such as cancel button 728b illustrated in FIG. 7b, to GUI subsystem 519. GUI subsystem 519 may instruct graphics subsystem 521 to draw the visual interface element(s) in a region of display presentation space 724b in FIG. 7b, based on the presentation information.

Input may be received via input driver 523 in FIG. 5. For example, a user may touch a location in presentation space 724b that includes a UI element identifying an operation, such as cancel button 728b. Input driver 523 may detect the touch and the location. The detected input may be received by GUI subsystem 519 via input driver 523 as an operation or command indicator based on the association of the shared location of the touch and cancel button 728b in presentation space 724b.

With reference to FIG. 2, block 202 illustrates that the method includes receiving first channel information identifying a first channel identifier bound to a first frequency channel accessible via a tuner. Accordingly, a system for configuring access to a data source based on a channel identifier includes means for receiving first channel information identifying a first channel identifier bound to a first frequency channel accessible via a tuner. For example, as illustrated in FIG. 4a, channel association component 402 is configured for receiving first channel information identifying a first channel identifier bound to a first frequency channel accessible via a tuner. FIG. 5 illustrates channel association component 502 as an adaptation and/or analog of channel association component 402 in FIG. 4a. One or more channel association components 502 operate in execution environment 501.

Channel information may identify a particular channel from the perspective of a user, for example, by a number or other identifier. A channel identifier differs from a channel of a television tuner and/or radio tuner. A channel for a tuner includes a frequency range, also referred to herein as a frequency channel, detectable to the tuner for producing output data. A particular frequency channel may be identified by a channel identifier, such as channel “3”. A channel identifier may be detected in response to user input identifying the channel identifier. A user may identify a particular channel identifier via software and/or hardware keys associated with numbers. TV remote controls and keypads are exemplary input devices for receiving specific channel identifiers in response to user input.

In another aspect, channel information may identify a channel identifier relative to another channel identifier. For example, a current channel identifier may identify a data source for which output is currently being presented and/or otherwise processed by a component in execution environment 501 in FIG. 5. Directional user interface controls such as up and down buttons on a TV remote control device may detect user input for identifying a next channel relative to the current channel based on an ordering of the channel identifiers. For numbered channels a next channel may be a next channel identifier numerically higher or lower than the current channel identifier.

Channel information identifying a channel identifier may be detected by input driver 523. In one aspect, input driver 523 may provide input information to GUI subsystem 519. GUI subsystem 519 may determine a location in a presentation space, such as presentation space 704a in FIG. 7a. A location may be determined based on the current location of a pointer icon or a detected touch on a touch screen. GUI subsystem 519 may determine a UI element presented in the location and provide the input data to an application component, such as UI element handler component 517 of an application, presenting the UI element. The channel information may be received by channel association component 502 for binding and/or otherwise associating a data source with the channel identifier identified by the channel information.

In another aspect, input driver 523 may provide input information for identifying a channel identifier to channel selector component 514 illustrated as a system component in execution environment 501. Channel selector component 514 may be a hardware component configured to distinguish between channel information including and/or referencing a channel identifier and channel information for identifying a channel identifier relative to another channel identifier. Whether a channel selector component is included as hardware and/or software, and whether a channel selector component is included in one or more applications operable in a A/V node and/or is included as a system component, a channel selector component may determine whether a detected input is for changing a current channel or whether the input is for binding a channel identifier to a data source. When channel information is received for binding, channel selector component 514 may provide channel information to channel association component 502. As illustrated in FIG. 5, channel selector component 514 and channel association component 502 may interoperate directly and/or may interoperate indirectly via content manager component 505 and binding system 525.

Channel selector component 514 may determine whether channel information is received for binding by checking a mode setting (not shown) in execution environment 501. Channel selector component 514 may determine that received channel information is for binding when the mode setting is set to a configuration mode. Channel information may be received for changing a current channel setting when the channel setting is in a presentation mode. In an aspect, channel information may be received for changing a current channel when the mode setting is set to a configuration mode as part of a configuration mode user interface and/or process.

The channel identified by the received channel information may identify a frequency channel of a tuner. In an aspect, the default data source bound to a channel identifier may be a frequency channel of a tuner, such as a television tuner.

In another aspect, A/V node 602 may instruct tuner component 515 to identify one or more channel identifiers bound to corresponding frequency channels of television tuner 515 which match a specified matching criterion. For example, the matching criterion may specify a threshold for signal strength of a frequency channel or may specify any other detectable criterion for matching. In one aspect, all frequency channels may automatically match. One or more channel identifiers bound to frequency channels that match the matching criterion may be identified in channel information received by channel association component 502. Matching channel identifiers may be indicated to be available for binding to data sources available other than via tuner 515.

Returning to FIG. 2, block 204 illustrates that the method further includes receiving first access information for accessing a first data source not accessible via the tuner. Accordingly, a system for configuring access to a data source based on a channel identifier includes means for receiving first access information for accessing a first data source not accessible via the tuner. For example, as illustrated in FIG. 4a, access configuration component 404 is configured for receiving first access information for accessing a first data source not accessible via the tuner. Fig. illustrates access configuration component 504 as an adaptation and/or analog of access configuration component 404 in FIG. 4a. One or more access configuration components 504 operate in execution environment 501.

Access information may identify a particular data source. Identifying a data source may include identifying a communications port, such as a particular HDMI port, or may include identifying a network accessible resource, such as a multimedia container accessible via a URL. Accessing a data source other than frequency channels of a tuner currently requires users to press various menu and navigation buttons to select a port or enter information for locating and/or otherwise accessing the data source via a data provider other than the tuner. In some cases, users must type in text, which is difficult for television devices that don't have keyboard input devices. Access information may be received by A/V node 602 in this manner via input driver component 523 and/or GUI subsystem 519 as described above.

In an aspect, access information may be pre-defined and stored in execution environment 501. For example, binding system 525 may include data representing access information for one or more predefined data sources. Access configuration component 504 may receive access information from binding system 525 in response to an event. For example, tuner 515 may detect a weak signal for a particular frequency channel and provide an indication that a channel identifier bound to the frequency channel is available for binding to another data source.

Alternatively or additionally, access information may be received from a removable data storage device, such as a USB data storage device. Still further, access information may be accessed from another node, such as a DHCP server and/or other directory server or database server.

A representation of access information for an HDMI port, a digital visual input (DVI) port, a network data source, another tuner device and/or tuner component, and/or a composite port may be presented in a hardware user interface and/or via an output device such as a display of A/V node 602. Selection information may be received in response to a user input detected by a remote control device and/or other input device. In response to the input, corresponding access information may be received by access configuration component 504.

In another aspect, a user may operatively connect a data source and/or data source device. For example, a user may turn on a DVD device. Content manager component 505 and/or channel access component 518 may receive information from a port component 503 communicatively coupling the DVD device and A/V node 602. In response to receiving the information, content manager component 505 and/or channel access component 518 may determine that A/V node 602 the detected data source may be bound to an a channel identifier. Content manager component 505 and/or channel access component 518 may generate access information identifying the port component 503 providing data from the DVD device and provide the identifying information in access information to access configuration component 504.

In another aspect, A/V node 602 may instruct channel access component 518 to identify one or more data sources automatically based on a specified matching criterion. The matching criterion may differ based on a particular type of port component, an attribute of a network data provider, and/or a resource accessible via a network data provider or port component. For example, for non-network sources, a port may match a matching criterion by being active. In another aspect, one or more network sources may be identified by sending a query to a search service operating in an identified node in network 618.

Returning to FIG. 2, block 206 illustrates that the method yet further includes creating a binding between the first channel identifier and the first access information. Accordingly, a system for configuring access to a data source based on a channel identifier includes means for creating a binding between the first channel identifier and the first access information. For example, as illustrated in FIG. 4a, access binder component 406 is configured for creating a binding between the first channel identifier and the first access information. FIG. 5 illustrates access binder component 506 as an adaptation and/or analog of access binder component 406 in FIG. 4a. One or more access binder components 506 operate in execution environment 501.

Channel information received by channel association component 502 and access information received by access configuration component 504 may be received by and/or otherwise identified to access binder component 506. Access binder component 506 in FIG. 5 is illustrated as a component of binding system 525 along with channel binder component 516, described below, and access manager component 508. Access manager component 508 may provide access to bindings identifying a channel identifier and a data source bound to the channel identifier stored in bindings data store 527.

In one aspect, a channel record identifying a channel identifier may be stored in bindings data store 527. Access binder component 506 may create a binding by updating the channel record identifying the channel identifier identified by the channel information based on the access information. A channel record may include and/or otherwise identify some or all of the access information. In an aspect, channel records are maintained for all channel identifiers whether they are bound to a data source or not. In another aspect, channel records are created and maintained in bindings data store 527 when bound to a data source.

In an aspect, access information may vary based on a particular data source, data source type, content type(s) provided by the data source, a particular port, and/or a port type. Access information may have differing formats and/or vocabularies based on differing attributes of the data sources identified and/or differing attributes of communications components and/or protocols for accessing the data sources. A standard set of access information data structures may be supported by access binder component 506, binding system component 525, access manager component 508, channel binder component 516, bindings data store 527, and/or other components included in processing some or all data in an instance of access information. In another aspect, binding system 525 and components included in binding system 525 may process access information records with formats and/or vocabularies that are dynamically generated and/or received. For example, an access information record may be created and/or otherwise processed based on a schema for the access information received from an external source. The external source may be a configuration source, removable storage, and/or a data source—to name a few examples.

Returning to FIG. 2, block 208 illustrates that the method yet further includes storing the binding in a data store to locate, based on a selection of the channel identifier, the access information for accessing data from the first data source rather than accessing data received in the first frequency channel. Accordingly, a system for configuring access to a data source based on a channel identifier includes means for storing the binding in a data store to locate, based on a selection of the channel identifier, the access information for accessing data from the first data source rather than accessing data received in the first frequency channel. For example, as illustrated in FIG. 4a, access manager component 408 is configured for storing the binding in a data store to locate, based on a selection of the channel identifier, the access information for accessing data from the first data source rather than accessing data received in the first frequency channel. FIG. 5 illustrates access manager component 508 as an adaptation and/or analog of access manager component 408 in FIG. 4a. One or more access manager components 508 operate in execution environment 501.

In FIG. 5, access binder component 506 in binding system 525 may retrieve and/or otherwise receive the channel information and the access information via access manager component 508. Access binder component 506 associates the channel identifier with the access information for accessing the data source identified by the access information when the channel identifier is selected for presentation and/or otherwise processing the data such as caching for later presentation. Access binder component 506 may store a record identifying the channel identifier based on the channel information and identifying the access information. The record may be stored in a data store illustrated by bindings data store 527. The data store may be included in A/V node 602, in another node such as media server node 620, and/or may be in a removable data storage medium for personalizing channels on A/V node 602 and/or for storing bindings for accessing in another A/V node and/or tuner-based system.

Access binder component 506 may interoperate with access manager component 508 to store bindings as binding information representing channel records, access information records, and/or analogs of channel records and access information records in bindings data store 527 and/or another data storage system and/or data storage device.

Channel bindings created by access binder component 506 may be accessible to other components of execution environment 501 and/or to other A/V nodes via bindings data store 527, via other data storage devices and systems, and via network 618 for identifying and accessing a data source bound to a channel identifier.

The method illustrated in FIG. 2 may include additional aspects supported by various adaptations and/or analogs of the arrangement of components in FIG. 4a. For example, channel information for binding may be received in response to detecting an input, from a user, to a numeric input control, and/or receiving information identifying a channel identifier available for binding. A numeric input control may include a hardware control for receiving a number as input from a user. A hardware control may include a numeric keypad and a navigation input control. The hardware control may be communicatively coupled to a node operatively coupled to a tuner, such as A/V node 602, and may be included in at least one of a remote control device, a keyboard, and a touch screen.

In another aspect, a numeric input control may include a user interface element presented via an output device. An input may be detected by an input device and determined to correspond to the user interface element. The correspondence may be based on a location of a UI pointer element, a location of a detected touch, a UI element including the numeric UI element having input focus, and/or a configuration of the input that defines the input to correspond to the numeric UI element.

Channel information may identify a channel identifier based on another channel identifier. For example, the first channel information may be received by channel association component 502 in FIG. 5, in response to receiving an input indicating a direction to navigate from a second channel identifier in an ordered arrangement of channel identifiers. The second channel identifier may be included in and/or otherwise identified by a current channel setting. Channel director component 512 may include and/or otherwise access the current channel setting.

In still another aspect, channel information identifying a channel identifier for binding may include automatically detecting a frequency channel accessible via a tuner that matches a specified matching criterion. For example, channel association component 502 may instruct tuner 515 to locate frequency channels with a signal strength below a specified threshold measure. Tuner 515 may respond by returning channel identifiers bound to the matching frequency channels. Channel association component 502 may generate and/or receive channel information for one or more channel identifiers detected and/or otherwise identified via the matching.

A representation of a channel identifier for binding may be presented via an output device. The representation may be presented along with representations of one or more other channel identifiers available for binding. Channel association component 502 may interoperate with presentation controller component 513 and/or one or more UI element handler components 517 to present the representations. The channel identifiers represented may match a specified matching condition for identifying channel identifiers available for binding. Presentation controller component 513 and/or one or more UI element handler components 517 may receive selection information identifying a particular channel identifier in response to a detected input that corresponds to a presented representation of the particular channel identifier. Channel association component 502 may select the particular channel identifier, in response to the input.

FIG. 7a illustrates a user interface presenting a number of data sources and channel identifiers bound to the data sources. The user interface may be presented by channel association component 502 via presentation controller 513. Bindings may be retrieved via binding system 525. A source column 708a identifies a data source port 503 and/or component in A/V node 502. A notes column 710a may provide additional data included in access information identified by a particular binding. The additionally may provide more information about the data source. A channel column 712a identifies a channel identifier or a set of channel identifiers bound to a corresponding data source. For example, channel identifiers “2” through “4” are bound to frequency channels accessible via tuner 515. Channel “5” is bound to a first HMDI port operatively coupled to a DVD device. FIG. 7a illustrates that channel identifier “11” is selected by the selection box 714a. A scrolling list 716a is presented to one side of the selection box 714a. Scrolling list 716a presents channel identifiers that are available. A user input selecting a channel identifier in scrolling list 716a may be received by association component 502 for binding to the access information for accessing data from network data provider identified by \\www.somesite.us\myPhotos. HTTP may be the access protocol not presented in the user interface.

In an aspect of the method illustrated in FIG. 2, receiving the access information may include detecting a currently accessed data source. For example, channel information may be received while data from a data source is being accessed and presented via an output device of A/V node 602. In response to receiving the channel information, access configuration component 504 may provide access information for the data source currently being accessed to access binder component 506 for binding to the channel identifier identified by the received channel information. Access configuration component 504 may provide the access information to access binder component 506 automatically in response to channel association component 502 receiving the channel information. In another aspect, a user input may be required to initiate the binding operation.

Receiving the first access information may include receiving the first access information while in a channel configuration mode for configuring the channel binding. Channel configuration mode may be entered in response to a user input for creating a binding. Channel configuration mode may end automatically when the binding is created. For example, while a current data source is being presented, a user input identifying a channel identifier may be received along with a user input for binding the channel identifier to the current data source. Channel association component 502 may receive channel information in response to the input, and access configuration component 504 may provide access information for the current data source to access binder component 506. A/V node 602 may enter configuration mode in response to detecting the user input for binding. In an aspect, configuration mode may remain active until a user input is received to end configuration mode. Access binder component 506 may receive the channel information and access information for creating the binding as described above.

In another aspect, when in a configuration mode, access configuration component 504 may query channel director component 512 to detect and/or otherwise identify data sources that are currently accessible. In response to receiving the query, channel director component 512 may monitor one or more data sources via one or more ports 503 and/or may determine whether one or more data sources are active and accessible. Representations of one or more accessible data sources may be presented to a user by access configuration component 504 based on information from channel director component 512 responding to the query. Access configuration component 504 may present the data source representations via presentation controller component 513. Access information for binding to a channel identifier may be selected in response to detecting user input corresponding to a data source representation presented to the user. In an aspect, channel director component 512 and/or channel access component 518 may iterate through a plurality of accessible data sources in response to a specified event, such as a user input, a timer event, and/or a notification of a new data source.

A selectable representation of a first data source may be presented via an output device while channel director component 512 and/or channel access component 518 iterate through the plurality of accessible data sources. While iterating through the data sources, channel director component 512 and/or channel access component 518 may receive selection information, based on a detected user input, identifying access information for the first data source in response to detecting an input corresponding to the selectable representation.

In another aspect, a data source may be detected in response to activation of the data source and/or detection of an active data source via a port and/or network interface component. Access information may be received by access configuration component 504, by channel access component 518, and/or by channel director component 512 via binding system 525 in response to detecting the data source. If channel information has not been received for creating a binding, binding system 525 may invoke channel association component 502 to receive channel information as described above.

In yet another aspect, access information may be received from another device communicatively coupled to A/V node 602. For example, the other device may include a directory service node, a DHCP node, and a removable data storage media device. A/V node 602 may request access information from another node, for example while operating in configuration mode. A/V node 602 may receive notifications of changes in data sources including obsolete data sources that may identify an available channel identifier and/or new data sources available for binding to a channel identifier. A/V node 602 may receive a notification based on a subscription established by and/or otherwise for A/V node 602 with a publisher service operating in a remote node. Exemplary publisher services includes really simple syndication (RSS) services and publish-subscribe services such as presence services.

Access information may include and/or otherwise identify a port in execution environment 501 for accessing data from a data source. Exemplary ports include an HDMI port, a DVI port, a composite port, a USB port, a network interface component, a radio tuner, and/or a television tuner. A radio tuner and/or a television tuner may receive over-the-air broadcast signals, satellite signals, and/or over-the-wire signals such as provided by cable television service provider 608.

Access information may identify a protocol for accessing data from a data source. Access information may identify an address from an address space of the protocol. Exemplary protocols and types of protocols include a physical layer protocol, a link layer protocol, a network layer protocol, a transport layer protocol, a session layer protocol, a presentation layer protocol, and/or an application layer. Access information may also include authentication information, authorization information, payment information, geospatial information, and/or demographic information as requested and/or required by a provider of a data source.

As described above, creating a binding may be performed automatically. Also as described above, creating a binding may be performed in response to a user input and/or other event indicating that a binding be created. For example, an indication to create a binding may be generated based on a timer. A/V node 602 may access data from a data source to present via an output device. Binding system 525 may determine that the data source is not bound to a channel identifier. A timer may be set by binding system 525. If the timer expires while the data source is still being accessed, binding system 525 may automatically bind access information for the data source to an available channel identifier, in one aspect. In another aspect, binding system 525 may invoke channel association component 502 to receive channel information to determine a channel identifier for creating a binding. An event indicating that a binding should be created may be based on a count of accesses to a data source. The count may be based on a duration of time, such as an average duration of time accessed.

Creating a binding may include generating a binding identifying a channel identifier and identifying access information for a data source. Access binder component 506 and/or access manager component 508 may generate binding information, in one aspect. In addition to identifying a channel identifier and access information, binding information may include and/or otherwise identify a user, a content type provided by the data source, a port, a node, a particular resource in a data source, and/or a resource for generating data from the data source.

Still further, a binding may include and/or otherwise identify a time when a binding is active. For example, channel “143” may be bound to a data source from 7 PM to 10 PM on weekdays. Binding information may include and/or otherwise identify geospatial information. For example, a binding may be active when a device is included in a geospatial region identified by the geospatial information. Channel “17” may be bound in Denver, Colo., and not bound in Raleigh, N.C.

A binding may be stored in any suitable data store. Exemplary data stores include a processor memory data store, a persistent data store, a removable data store, and/or a network accessible data store. Alternatively or additionally, a binding may be stored by sending binding information via a network to a binding node. The stored binding may be accessible to other nodes for identifying a data source bound to a channel identifier. A binding may be stored in a removable data storage device. The removable data storage device may be operatively coupled to another node to identify a data source for a channel identifier.

With reference to FIG. 3, block 302 illustrates that the method includes detecting first channel information identifying a first channel identifier bound to a first frequency channel accessed, via a tuner, as a first data source for a first presentation being presented, based on first data from the first data source, via an output device. Accordingly, a system for selecting a data source based on a channel identifier includes means for detecting first channel information identifying a first channel identifier bound to a first frequency channel accessed, via a tuner, as a first data source for a first presentation being presented, based on first data from the first data source, via an output device. For example, as illustrated in FIG. 4b, channel director component 412 is configured for detecting first channel information identifying a first channel identifier bound to a first frequency channel accessed, via a tuner, as a first data source for a first presentation being presented, based on first data from the first data source, via an output device. FIG. 5 illustrates channel director component 512 as an adaptation and/or analog of channel director component 412 in FIG. 4b. One or more channel director components 512 operate in execution environment 501.

FIG. 5 includes channel director component 512 for tracking a current channel identifier selected for identifying a data source being presented and/or otherwise processed. For example, channel director component 512 may access a current channel setting to track the current channel identifier. Channel director component 512 may store the current channel identifier in the current channel setting in a volatile memory and/or may store the current channel identifier in a persistent memory to access the identified data source across a power-down and power-up cycle of A/V node 602. Channel director component 512 may access the current channel setting on power-up and/or may otherwise be configured to identify a default current channel.

A stored current channel accessed in response to powering on of A/V node 602 and/or accessing of a recalled current channel across a power-down/power-up cycle may change according to a current identified user of A/V node 602. The current user may be identified based on user information stored in a removable data storage device and/or based on input information received by A/V node 602.

A current channel identifier may identify a frequency channel accessible via tuner 515.

Returning to FIG. 3, block 304 illustrates that the method further includes detecting second channel information identifying a second channel identifier during the first presentation. Accordingly, a system for selecting a data source based on a channel identifier includes means for detecting second channel information identifying a second channel identifier during the first presentation. For example, as illustrated in FIG. 4b, channel selector component 414 is configured for detecting second channel information identifying a second channel identifier during the first presentation. FIG. 5 illustrates channel selector component 514 as an adaptation and/or analog of channel selector component 414 in FIG. 4b. One or more channel selector components 514 operate in execution environment 501.

As described above, channel information may be received by channel selector component 514 in response to a user input detected by input driver component 523. When A/V node 602 is in presentation mode, as opposed to configuration mode or other configuration mode, channel selector component 514 may provide the received channel information to channel director component 512. As described above, the channel information may include and/or reference a particular channel identifier or may provide information for determining a channel identifier relative to the current channel identifier maintained by channel director component 512.

In either case, channel director component 512 determines a second channel identifier for changing the first channel identified as the current channel to the identified second channel.

Returning to FIG. 3, block 306 illustrates that the method yet further includes identifying a binding between the second channel identifier and second access information for accessing a second data source via a data access component other than the tuner. Accordingly, a system for selecting a data source based on a channel identifier includes means for identifying a binding between the second channel identifier and second access information for accessing a second data source via a data access component other than the tuner. For example, as illustrated in FIG. 4b, channel binder component 416 is configured for identifying a binding between the second channel identifier and second access information for accessing a second data source via a data access component other than the tuner. FIG. 5 illustrates channel binder component 516 as an adaptation and/or analog of channel binder component 416 in FIG. 4b. One or more channel binder components 516 operate in execution environment 501.

Channel director component 512 may identify the channel identifier to channel binder component 516 in binding system 525. Channel binder component 516 may be instructed to change the current channel setting to the channel identifier identified by the second channel information to change the current data source for A/V node 602. Channel binder component 516 may locate access information identifying a data source bound, as described above, to the channel identified by the second channel information. Channel binder component 516 may instruct access manager component 508 to locate a channel record identifying the second channel identifier. Access manager component 508 may access information bound to the second channel identifier as described above to identify the binding between the second channel identifier and the second access information.

Returning to FIG. 3, block 308 illustrates that the method additionally includes accessing, via the data access component, the second data source for presenting, via an output device, a second presentation based on the second data from the second data source. Accordingly, a system for selecting a data source based on a channel identifier also includes means for accessing, via the data access component, the second data source for presenting, via an output device, a second presentation based on the second data from the second data source. For example, as illustrated in FIG. 4b, the channel access component 418 is configured for accessing, via the data access component, the second data source for presenting, via an output device, a second presentation based on the second data from the second data source. FIG. 5 illustrates channel access component 518 as an adaptation and/or analog of channel access component 418 in FIG. 4b. One or more channel access components 518 operate in execution environment 501.

In one aspect, a binding may not exist. When a binding is not determined and/or otherwise not located, channel binder component 516 may provide an indicator to channel director component 512 that the second channel identifier is accessible via TV port 503a. Channel binder component 516 may identify TV port component 503a indicating that a frequency channel accessible via tuner 515 that corresponds to the second channel identifier is the second data source. Alternatively, channel binder component 516 may return an error when no binding is located. Channel director component 512, in response, may process the second identifier as a frequency channel identifier by default.

When a binding is located, the access information bound to the second channel identifier may be retrieved by channel binder component 516 and returned to channel director component 512 for changing the current data source.

In one aspect, access information identified by a located binding may identify a frequency channel of tuner 515. The frequency range identified by the access information may differ from a frequency range normally associated with the second channel identifier. Channel director component 512 and/or channel access component 518 may map the second channel identifier of the bound frequency channel identified in the access information to an identifier recognizable by tuner 515 as corresponding to the frequency channel bound to the second channel information by the binding. Channel access component 518 may provide channel mapping information to TV port component 503a to access the television tuner frequency channel identified by the access information in the located binding.

In another aspect, access information in the located binding may identify an HDMI, DVI, composite, and/or other port communicatively coupled to DVD device 612. Channel director component 512 may identify the port component identified in the access information to channel access component 518. Channel access component 518 may configure content manager 505 to receive data from the identified port to access data from DVD device 612. Thus, a user may watch data provided by DVD device 612 by selecting a configured channel identifier, such as channel number “12”.

In yet another aspect, a channel identifier may be bound to access information for accessing a data source via a data provider accessible via network 618, as illustrated by data provider node 622 and/or media server node 620. For example, the identified access information may include and/or otherwise identify a universal resource identifier (URI), such as a universal resource locator (URL). A URL may identify a protocol based on a URL scheme, such as HTTP, RTP, and/or SIP. The data accessed may be static data such as an image and/or may include dynamic data such as a media stream. The data may be interactive or non-interactive.

Channel director component 512 may change the current channel setting to identify the second channel identifier. Channel director component 512 may instruct content manager component 505 to halt processing data from the data source bound to the former current channel identifier and/or may instruct a data provider and/or communications port to halt providing data to content manager component 505 for processing.

The method illustrated in FIG. 3 may include additional aspects supported by various adaptations and/or analogs of the arrangement of components in FIG. 4b. For example, detecting the first channel information may include detecting a current channel setting defined to identify a current data source for a current presentation. The first channel information may be identified by the current channel setting. The current channel setting may be maintained by channel director component 512 and/or any other suitable component(s). The current channel setting may be stored in a location in a volatile data storage medium during operation of A/V node 602 and may be stored in a persistent data storage medium when A/V node 602 is off or in a low power state.

Detecting the second channel information may include receiving a change channel indicator for changing the current channel setting to identify the second channel information. The current channel setting may be modified to identify the second channel information in correspondence with presenting the second presentation as a current presentation. A change indicator may be detected by channel selector component 514 in response to a user input. The change indicator may be communicated to channel director component 512 to direct the change process. Alternatively or additionally, a change indicator may be received by binding system 525 in response to an event. For example, binding system 525 may maintain a schedule for accessing a data source bound to a channel identifier. Channel “5” for example may be associated with a time period, such as 8 PM to 8:30 PM. Binding system 525 may receive a notification at 8 PM. Binding system 525 may process the notification as a change indicator based on the association of channel “5” with the time period. Binding system 525 may identify channel “5” to channel director component 512 to change the current channel setting in response to the change indicator.

Channel information for accessing a data source bound to a channel identifier may be received via a network. For example, schedule information described in the previous paragraph may be maintained by media server node 620. Media server node 620 may send a change indicator notification message via LAN 616 in response to detecting a clock indicating 8 PM. Alternatively or additionally, a binding may be configured to be activated when its data source is active. Channel information for accessing the data source may be detected and/or identified in response to detecting data received from the data source. In an example, a user may insert a DVD into DVD device 612. DVD device 612 may send data to HDMI port 503d to provide data stored on the DVD to A/V node 602 to present via one or more output devices to a user. Channel access component 518 may detect that HDMI port 503d has received data. Channel access component 518 and/or channel director component 512 may interoperate with binding system 525 to identify a channel identifier bound to DVD device 612 and/or HDMI port 503d. Binding system 525 may provide the channel information to channel director component 512 in response to locating the binding.

As described above, second channel information for changing a data source may be received in any of the various aspects described above. Second channel information may be received in response to input detected corresponding to a numeric input control and/or in response to receiving a change channel indicator. A numeric input control may be a hardware control for receiving a number as input from a user. The hardware control may include a numeric keypad and/or a navigation input control. The hardware control is communicatively coupled to A/V node 602. For example, a hardware control may include a remote control device, a keyboard, and/or a touch screen.

As described above, a numeric input control may include a user interface element presented via an output device. An input may be detected by an input device. A determination may be made that the input corresponds to the user interface element. For example, the correspondence may be determined based on a location of a UI pointer element, a location of a detected touch, a UI element including the numeric UI element having input focus, and/or a configuration of the input that defines the input to correspond to the numeric UI element.

Also described above, second channel information may identify the second channel identifier based on the first channel identifier. For example, second channel information may be received in response to receiving an input indicating a direction to navigate from the first channel identifier to the second channel identifier in an ordered arrangement of channel identifiers.

Accessing the second data may include modifying the current channel setting to identify the second channel identifier. Modifying the current channel setting may include activating a port to communicate with the second data source. Channel director component 512 in FIG. 5 may modify the current channel setting to identify the second channel identifier. Channel access component 518 may route data from a port 503, a protocol component 511, and/or network stack 509 to one or more content handler components 507 to present the data via one or more output devices of execution environment 501. Channel access component 518 may end accessing of data from the first data source in one aspect. In another aspect, data from the first data source may be routed to a data store to record the data and/or routed to another device for processing.

Channel access component 518 may send data to a data source, based on the access information, to access data from the data source. The data may be sent to power on, boot, wake up, and/or otherwise prepare a device including a data source to provide data from the data source. For a web data source, access information may identify a URL. Channel access component 518 may send a request to a node, such as data provider node 622, to request data from the identified data source.

Authentication information and/or authorization information may be sent to a data provider for accessing a data source. The authentication information and/or authorization information may be retrieved based on the access information and/or received from a user.

Accessing data from a data source may further include transforming the data into presentation information. As described above, one or more content handler components 507 may generate presentation information based on data received from a data source. The one or more content handler components 507 may send the presentation information for presenting a presentation via an output device. Presentation controller component 513 and/or one or more UI element handlers 517 may be included in sending the presentation information to the output device. Alternatively or additionally, content manager component 505 may send the presentation information via network 618 to another node for presenting by an output device included in an execution environment of the other node.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for configuring access to a data source based on a channel identifier, the method comprising:
receiving first channel information identifying a first channel identifier bound to a first frequency channel accessible via a tuner;
receiving first access information for accessing a first data source not accessible via the tuner;
creating a binding between the first channel identifier and the first access information; and
storing the binding in a data store to locate, based on a selection of the channel identifier, the access information for accessing data from the first data source rather than accessing data received in the first frequency channel.

2. The method of claim 1 wherein receiving the first channel information comprises:
detecting a frequency channel accessible via the tuner that matches a specified matching criterion;
determining that the first channel identifier is bound to the frequency channel; and
generating first channel information in response to determining the determining that the first channel identifier is bound to the frequency channel.

3. The method of claim 1 wherein receiving the first access information includes detecting a currently accessed data source.

4. The method of claim 1 wherein receiving the first access information includes detecting that the first data source is accessible.

5. The method of claim 4 wherein receiving the first access information comprises:
iterating through a plurality of accessible data sources including the first data source; and
determining that the first data source is accessible while iterating.

6. The method of claim 5 wherein identifying the first access information comprises:
presenting a selectable representation of the first data source via an output device while iterating through the plurality of accessible data sources; and
receiving selection information identifying the first access information in response to detecting an input corresponding to the selectable representation.

7. The method of claim 5 wherein the first data source is detected as accessible in response to activation of a first data provider of the first data source

8. The method of claim 1 wherein receiving the first access information includes receiving the access information from another device via a network.

9. The method of claim 1 wherein receiving the first access information includes receiving the first access information via a network based on a subscription provided by a publisher node.

10. The method of claim 1 wherein the first access information identifies at least one of an HDMI port, a DVI port, a composite port, a USB port, a network interface component, a radio tuner, and a television tuner.

11. The method of claim 10 wherein the access information identifies at least one of a service for generating data and a resource including data accessible via the at least one of the HDMI port, the DVI port, the composite port, the USB port, the network interface component, the radio tuner, and the television tuner.

12. The method of claim 1 wherein the access information identifies at least one a physical layer protocol, a link layer protocol, a network layer protocol, a transport layer protocol, a session layer protocol, a presentation layer protocol, an application layer, an address for communicating via a communications protocol, authentication information, authorization information, payment information, geospatial information, and demographic information.

13. The method of claim 1 wherein the binding is created automatically in response to receiving the first channel information and the first access information.

14. The method of claim 1 wherein the binding is created in response to detecting a binding indication based on at least one of a user input and a binding event.

15. The method of claim 14 wherein detecting the binding event is based on detecting a time period having a duration that matches a specified binding duration condition.

16. The method of claim 1 wherein creating the binding includes generating binding information identifying the first channel identifier and the first data source.

17. The method of claim 1 wherein the binding information includes at least one of a time identifying when the binding is active and geospatial information identifying a location where the binding is active.

18. The method of claim 1 wherein storing the binding includes at least one of sending the binding information via a network to a binding node accessible for storing the binding and storing the binding in a removable data storage medium for accessing by another device.

19. A system for configuring access to a data source based on a channel identifier, the system comprising:
an execution environment including an instruction-processing unit configured to process an instruction included in at least one of a channel association component, an access configuration component, and an access binder component, and an access manager component;
the channel association component configured for receiving first channel information identifying a first channel identifier bound to a first frequency channel accessible via a tuner;
the access configuration component configured for receiving first access information for accessing a first data source not accessible via the tuner; and
the access binder component configured for creating a binding between the first channel identifier and the first access information; and
the access manager component configured for storing the binding in a data store to locate, based on a selection of the channel identifier, the access information for accessing data from the first data source rather than accessing data received in the first frequency channel.

20. A computer-readable medium embodying a computer program, executable by a machine, for configuring access to a data source based on a channel identifier, the computer program comprising executable instructions for:
receiving first channel information identifying a first channel identifier bound to a first frequency channel accessible via a tuner;
receiving first access information for accessing a first data source not accessible via the tuner; and
creating a binding between the first channel identifier and the first access information.
